(19) United States
(12) Patent Application Publication
(10) Pub. No.: US 2024/0329217 A1
(43) Pub. Date: Oct. 3, 2024

(54) LiDAR-Reinigungssystem

(71) Applicant: Robert Bosch GmbH, Stuttgart (DE)

(72) Inventors: Bence Balint, Monor (HU); Akos Hegyi, Mezöhegyes (HU); Gyorgy Szabo, Budapest (HU); Janos Simonovics, Dunaharaszti (HU); Mate Hornyak, Pakozd (HU); Peter Deak, Budapest (HU); Zoltan Gyonyoru, Budapest (HU)

(21) Appl. No.: 18/615,396

(22) Filed: Mar. 25, 2024

(30) Foreign Application Priority Data
Mar. 27, 2023 (DE) 10 2023 202 783.6

(51) Int. Cl. G01S 7/497; G01S 7/481; G02B 27/00

(52) U.S. Cl. CPC G01S 7/497; G01S 7/4813; G02B 27/0006; G01S 2007/4977

(57) ABSTRACT

The present invention relates to a LiDAR cleaning system comprising an actuator, which is configured to drive a first spindle element and a second spindle element, a first rod element, which is displaceably arranged on the first spindle element, a second rod element, which is displaceably arranged on the second spindle element, a wiper unit, which is displaceably arranged on the first rod element and the second rod element, wherein the actuator is configured to displace the wiper unit towards a sensor surface of a LiDAR sensor by means of a first displacement of the first rod element along the first spindle element and by means of a second displacement of the second rod element along the second spindle element in order to clean the sensor surface with the wiper unit.

### BACKGROUND

The present invention relates to a LiDAR cleaning system and a vehicle.

There are currently a plurality of different solutions for cleaning surfaces in the vehicle area. Due to the increasing number of sensor surfaces to be cleaned on vehicles and the increased requirements of autonomous driving, the demand for robust and innovative cleaning methods is continuously increasing.

Steady weight reduction in the vehicle area to reduce consumption and increasing competition create cost pressure so that cheaper and more efficient components for vehicles are more in demand.

### SUMMARY

The LiDAR cleaning system according to the invention has the advantage over the known systems that with the aid of the first spindle element and the second spindle element, the position of the wiper unit can be approached very precisely in order to thus further improve a cleaning operation of the LiDAR sensor. Furthermore, due to the first spindle element and the second spindle element, the LiDAR cleaning system has increased robustness as the movement of the wiper unit towards the LiDAR sensor runs along a predefined path. A further advantage of the LiDAR cleaning system is that the first spindle element and the second spindle element can be arranged on a side face of the LiDAR sensor and thus the required design space of the LiDAR sensor is significantly reduced with the cleaning system.

This is solved according to the invention in that the LiDAR cleaning system comprises an actuator, which is configured to drive a first spindle element and a second spindle element. Furthermore, the LiDAR cleaning system comprises a first rod element that is displaceably arranged on the first spindle element. In addition, the LiDAR cleaning system comprises a second rod element that is displaceably arranged on the second spindle element. Furthermore, the LiDAR cleaning system comprises a wiper unit which is displaceably slidably arranged on the first rod element and the second rod element. Furthermore, the actuator is configured to displace the wiper unit towards a sensor surface of a LiDAR sensor by means of a first displacement of the first rod element along the first spindle element and by means of a second displacement of the second rod element along the second spindle element in order to clean the sensor surface with the wiper unit.

In other words, by rotating the first spindle element and the second spindle element, the first rod element and the second rod element may be displaced relative to each other, such that the wiper unit is displaced along the sensor surface. The actuator may have a first drive that drives the first spindle element and a second drive that drives the second spindle element. Furthermore, the actuator may have a single drive that drives both the spindle element and the second spindle element. Furthermore, the actuator may have at least one transmission that transmits a rotation or the like in order to displace the wiper unit towards the sensor surface.

The first rod element is arranged on the first spindle element such that it is moved along a first displacement. The second rod element is arranged on the second spindle element such that it can be moved along a second displacement. The first displacement and the second displacement are in particular opposite to one another. Furthermore, the wiper unit can be displaceably or slidably arranged on the first rod element and the second rod element. For example, the first rod element and the second rod element have a surface or lubrication that assists in displacing the wiper unit along the sensor surface.

The dependent claims disclose preferred embodiments of the invention.

Preferably, the first rod element comprises a first carriage arranged on a first transverse guide, wherein the second rod element comprises a second carriage arranged on a second transverse guide.

An advantage of this embodiment is that the torsion forces occurring on the wiper unit caused by the displacement of the rod elements can be significantly reduced by the transverse guides with the respective carriages, as the rod elements on the transverse guide can be tracked with the carriage.

In other words, the first spindle element and the second spindle element are arranged on a first side of the LiDAR sensor. The first transverse guide and the second transverse guide are arranged on a second side of the LiDAR sensor. The first rod element and the second rod element may extend across the width of the sensor surface. By means of tracking using the carriage at the transverse guide, the torsion forces occurring are significantly lower, such that less energy is required for the displacement of the wiper unit.

Preferably, the first spindle element, the second spindle element, the first transverse guide, and the second transverse guide are arranged substantially parallel to one another.

An advantage of this embodiment is that the rod elements are selectively displaceable with respect to each other and thus a position of the wiper unit can be specifically adjusted relative to the sensor surface. In this context in particular, substantially parallel means a deviation of ±15°.

Further preferably, the first displacement and the second displacement are substantially opposite.

An advantage of this embodiment is that with the aid of a single drive, for example an electric step or brushless motor, both the first spindle element and the second spindle element can be driven to displace the wiper unit along the sensor surface.

Preferably, the first spindle element has a first surface contour, wherein the first surface contour is configured to define a first displacement direction of the first displacement, wherein the second spindle element has a second surface contour, which is configured to define a second displacement direction of the second displacement, wherein the first displacement direction and the second displacement direction are arranged opposite to one another.

An advantage of this embodiment is that with the aid of a single drive, for example an electric step or brushless motor, both the first and the second spindle element can be driven to displace the wiper unit along the sensor surface.

Preferably, the first spindle element has a first surface contour, wherein the first surface contour is configured to define a first displacement direction of the first displacement, wherein the second spindle element has a second surface contour, which is configured to define a second displacement direction of the second displacement, wherein the first displacement direction and the second displacement direction are arranged opposite to one another.

An advantage of this embodiment is that with simple means, for example a surface contour of the spindle element, in particular a threaded rod, the wiper unit can be displaced towards the sensor surface. For example, the first surface contour may be a right-hand threaded rod, wherein the second surface contour may be a left-hand threaded rod. Thus, the left-hand or right-hand threaded rod also specifies the displacement direction during a rotation of the first or second spindle element.

The first spindle element and the second spindle element are arranged on a side face of the LiDAR sensor, wherein the wiper unit comprises a lip for cleaning the sensor surface, wherein the sensor surface and the side face are arranged at an angle of about 90° to one another.

An advantage of this embodiment is that the required design space of the LiDAR sensor can be significantly reduced with the LiDAR cleaning system as the spindle elements and the wiper unit are arranged offset from one another. For example, both the first spindle element and the second spindle element may be arranged at a top side or bottom side of the LiDAR sensor. Furthermore, the sensor interface may be a front side of the LiDAR sensor. The front side of the LiDAR sensor and the top side or bottom side of the LiDAR sensor may be arranged at an angle of about 90°. In this context, “about 90°” can mean a deviation of ±15°.

Preferably, the lip is fastened to the wiper unit by means of a wiper arm, wherein the wiper arm is releasably arranged on the wiper unit.

An advantage of this embodiment is that the lip on the cleaning arm can be easily changed without having to remove the LiDAR cleaning system or the LiDAR sensor.

Preferably, the wiper unit comprises a spring element configured to press the wiper arm and/or the lip against the sensor surface.

An advantage of this embodiment is that with the aid of the spring element, a biasing force of the lip or the wiper arm can be increased on the sensor surface and thus the cleaning performance of the LiDAR cleaning system can be further improved.

The wiper unit comprises a displacement element, wherein the displacement element comprises a first bore and a second bore, wherein the first rod element is arranged in the first bore, wherein the second rod element is arranged in the second bore, wherein the displacement element is displaceable along the first rod element and the second rod element by means of a rotation of the first spindle element and the second spindle element.

An advantage of this embodiment is that with the aid of a simple and inexpensive element, the wiper unit can be displaceably arranged on the first and the second rod elements. Furthermore, it may be advantageous that by simply lubricating the rod element, a displacement of the wiper unit along the sensor surface has a significantly lower energy consumption.

Further preferably, the LiDAR cleaning system comprises a housing at least partially enclosing the first spindle element and the second spindle element.

An advantage of this embodiment is that both the first and the second spindle elements are protected from environmental factors, for example contamination, which are stirred up from the roadway, and thus a rotation or displacement of the rod elements may also occur in adverse circumstances.

Preferably, the first rod element is arranged on the first spindle element by means of a first threaded element, wherein the second rod element is arranged on the second spindle element by means of a second threaded element.

An advantage of this embodiment is that the position of the rod elements in relation to the spindle element can be adjusted specifically by means of the threaded elements.

In other words, the first rod element comprises a first threaded element, which can be arranged on a right-hand threaded rod, for example. In addition, the second rod element may comprise a second threaded element, which in particular can be connected to a left-hand threaded rod, which can be the second spindle element.

A further aspect of the invention relates to a vehicle comprising a LiDAR sensor and a LiDAR cleaning system as described above and below.

### BRIEF DESCRIPTION OF THE DRAWINGS

Exemplary embodiments of the invention are described in detail hereinafter with reference to the accompanying drawings. The drawings show:

FIGS. 1 through 6 a LiDAR cleaning system according to one embodiment, and

FIG. 7 a vehicle according to one embodiment.

### DETAILED DESCRIPTION

Preferably, all identical components, elements, and/or units are provided with the same reference symbols in all figures.

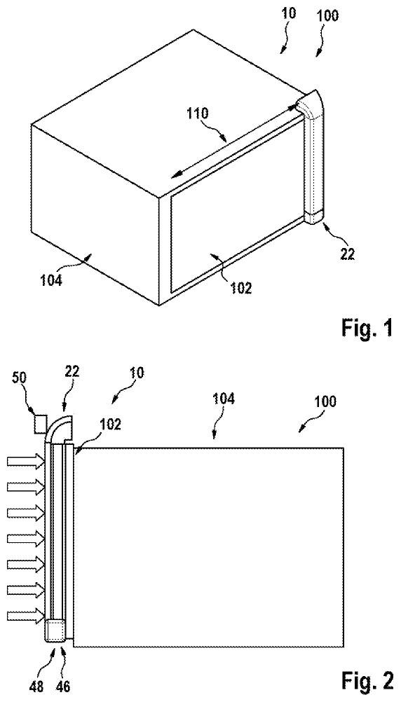

FIG. 1 shows a LiDAR cleaning system 10 according to one embodiment. The LiDAR cleaning system 10 is arranged on a LiDAR sensor 100. The LiDAR sensor 100 has a sensor surface 102 through which the LiDAR sensor 100 can send and receive signals. Furthermore, the LiDAR sensor 100 has a side face 104. Furthermore, the LiDAR cleaning system 10 can displace the wiper unit 22 along a displacement direction 110.

FIG. 2 shows a LiDAR cleaning system 10 according to one embodiment. The LiDAR cleaning system 10 is arranged on a LiDAR sensor 100, which can send and receive signals by means of a sensor surface 102. Furthermore, the LiDAR sensor 100 has a side face 104. Furthermore, the LiDAR cleaning system 10 comprises a wiper unit 22. The wiper unit 22 comprises a spring element 50, which presses a wiper arm 48 with a lip 46 to the sensor surface 102.

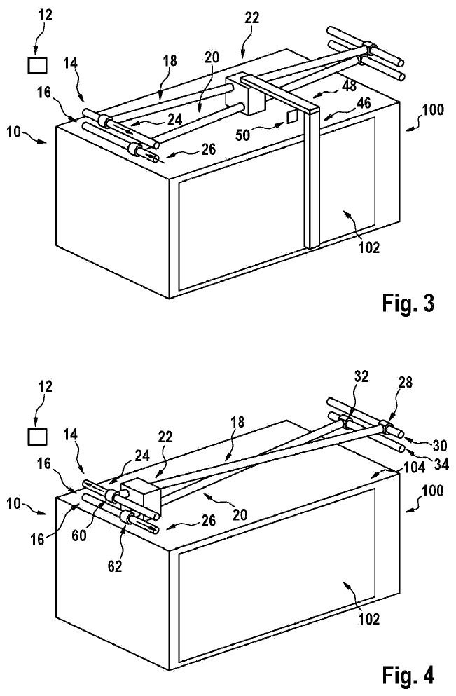

FIG. 3 shows a LiDAR cleaning system 10 according to one embodiment. The LiDAR cleaning system 10 comprises an actuator 12. The actuator 12 is configured to drive a first spindle element 14 and a second spindle element 16. The actuator 12 may rotate the first spindle element 14, in particular such that the first rod element 18 is displaced along a first displacement 24. Furthermore, the actuator 12 may rotate the second spindle element 16 such that the second rod element 20 is displaced along a second displacement 26. The first displacement 24 of the first rod element 18 and the second displacement 26 of the second rod element 20 may cause the wiper unit 22 to be displaced along the sensor surface 102. In so doing, the wiper unit 22 may comprise a spring element 50 that presses a cleaning arm 48 with a lip 46 against the sensor surface 102.

FIG. 4 shows an embodiment of the LiDAR cleaning system 10. The LiDAR cleaning system 10 comprises an actuator 12. The first rod element 18 is arranged on the first spindle element 14 by means of a first threaded element 60. Thus, the actuator 12 may rotate the first spindle element 14, for example a right-hand threaded rod, such that the first rod element 18 is displaced along the first displacement 24. Furthermore, the second rod element 20 may be arranged on the second spindle element 16 by means of a second threaded element 62. Thus, the actuator 12 may displace the second rod element along a second displacement 26 by rotation of the second spindle element 16, which is, for example, a left-hand threaded rod. Furthermore, the LiDAR cleaning system 10 comprises a first transverse guide 30 and a second transverse guide 34. The first rod element 18 comprises a first carriage 28, which is displaceably arranged on the first transverse guide 30. Furthermore, the second rod element 20 may comprise a second carriage 32 that displaceably arranges the second rod element 20 on the second transverse guide 34. Furthermore, the first spindle element 14, the second spindle element 16, the first transverse guide 32, and the second transverse guide 34 may be arranged on a side face 104 of the LiDAR sensor.

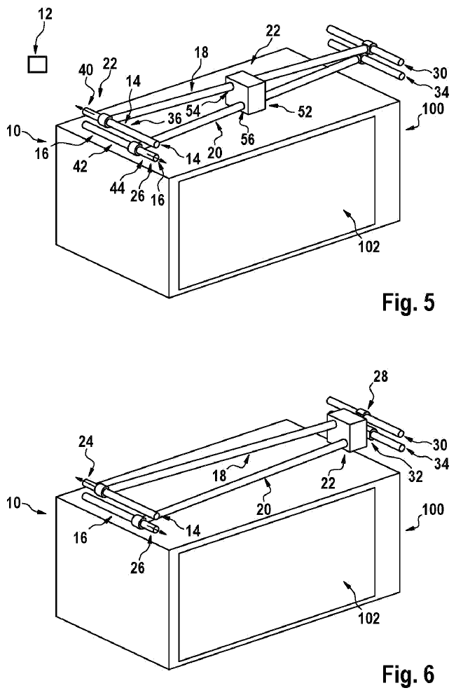

FIG. 5 shows an embodiment of the LiDAR cleaning system 10. The LiDAR cleaning system 10 comprises an actuator 12. The actuator 12 can drive the first spindle element 14 and the second spindle element 16. The first spindle element 14 has a first surface contour 36, which defines a first displacement direction 40 of the first displacement 24. For example, the first surface contour 36 may be formed from a right-hand threaded rod.

Furthermore, the second spindle element 16 has a second surface contour 42 defining a second displacement direction 44 of the second displacement 26. For example, the second surface contour 42 may form a left-hand threaded rod. Furthermore, the wiper unit 22 can comprise a displacement element 52. The displacement element 52 can have a first bore 54 and a second bore 56. The first rod element 18 may be displaceably arranged in the first bore 54. Furthermore, the second rod element 20 may be displaceably arranged in the second bore 56.

FIG. 6 shows a LiDAR cleaning system 10 with a first spindle element 14, a second spindle element 16 and a first rod element 18 with a second rod element 20, which are arranged on the first spindle element 14 on a second spindle element 16. Furthermore, by means of the first spindle element 14, the first rod element 18 can be displaced along a first displacement 24. In addition, the second rod element 20 may be displaced along a second displacement 26 by means of the second spindle element. The first rod element 18 can in particular be displaceably arranged on the first transverse guide 30 by means of a first carriage 28. The second rod element 20 can be arranged on the second transverse guide by means of a second carriage 32.

Furthermore, FIGS. 4 to 6 show different deflection states of the LiDAR cleaning system 10. As shown in FIG. 4, the wiper unit 22 has a maximum displacement towards a first side, wherein the wiper unit 22 is arranged nearly on the first spindle element 14 and the second spindle element 16. In FIG. 5, the wiper unit 22 is in a central position, wherein the center of the position can in particular be defined by the distance between the first spindle element 14 or the second spindle element 16 and the first transverse guide 30 or the second transverse guide 34, respectively. Furthermore, FIG. 6 shows a maximum deflection state of the wiper unit 22 towards a second side, wherein the wiper unit 22 has been displaced near the first transverse guide 30 and the second transverse guide 34.

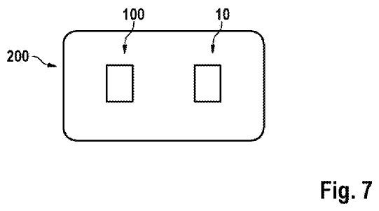

FIG. 7 shows a vehicle 200 which has a LiDAR sensor 100 and a LiDAR cleaning system 10, as described above.

1. A LiDAR cleaning system (10) comprising:
an actuator (12) configured to drive a first spindle element (14) and a second spindle element (16),
a first rod element (18), which is displaceably arranged on the first spindle element (14),
a second rod element (20), which is displaceably arranged on the second spindle element (16),
a wiper unit (22), which is displaceably arranged on the first rod element (18) and on the second rod element (20),
wherein the actuator (12) is configured to displace the wiper unit (22) towards a sensor surface (102) of a LiDAR sensor (100) by means of a first displacement (24) of the first rod element (18) along the first spindle element (14) and by means of a second displacement (26) of the second rod element (20) along the second spindle element (16) in order to clean the sensor surface (102) with the wiper unit (22).

2. The LiDAR cleaning system (10) according to claim 1, wherein the first rod element (18) comprises a first carriage (28) arranged on a first transverse guide (30), wherein the second rod element (20) comprises a second carriage (32) arranged on a second transverse guide (34).

3. The LiDAR cleaning system (10) according to claim 2, wherein the first spindle element (14), the second spindle element (16), the first transverse guide (30), and the second transverse guide (34) are arranged substantially parallel to one another.

4. The LiDAR cleaning system according to claim 1, wherein the first displacement (24) and the second displacement (26) are substantially opposite.

5. The LiDAR cleaning system (10) according to claim 1, wherein the first spindle element (14) has a first surface contour (36), wherein the first surface contour (36) is configured to define a first displacement direction (40) of the first displacement (24), wherein the second spindle element (16) has a second surface contour (42), which is configured to define a second displacement direction (44) of the second displacement (26), wherein the first displacement direction (40) and the second displacement direction (44) are opposite to one another.

6. The LiDAR cleaning system (10) according to claim 1, wherein the first spindle element (14) and the second spindle element (16) are arranged on a side face (104) of the LiDAR sensor (100), wherein the wiper unit (22) comprises a lip (46) for cleaning the sensor surface (102), wherein the sensor surface (102) and the side face (104) are arranged at an angle of about 90° to one another.

7. The LiDAR cleaning system (10) according to claim 6, wherein the lip (46) is fastened to the wiper unit (22) by means of a wiper arm (48), wherein the wiper arm (48) is releasably arranged on the wiper unit (22).

8. The LiDAR cleaning system (10) according to claim 1, wherein the wiper unit (22) comprises a spring element (50) configured to press the wiper arm (48) and/or the lip (46) against the sensor surface (102).

9. The LiDAR cleaning system (10) according to claim 1, wherein the wiper unit (22) comprises a displacement element (52), wherein the displacement element (52) comprises a first bore (54) and a second bore (56), wherein the first rod element (18) is arranged in the first bore (54), wherein the second rod element (20) is arranged in the second bore (56), wherein the displacement element (52) is displaceable along the first rod element (18) and the second rod element (20) by means of a rotation of the first spindle element (14) and the second spindle element (16).

10. The LiDAR cleaning system (10) according to claim 1, wherein the LiDAR cleaning system (10) comprises a housing (58) which at least partially encloses the first spindle element (14) and the second spindle element (16).

11. The LiDAR cleaning system (10) according to claim 1, wherein the first rod element (18) is arranged on the first spindle element (14) by means of a first threaded element (60), wherein the second rod element (20) is arranged on the second spindle element (16) by means of a second threaded element (62).

12. A vehicle (200) comprising a LiDAR sensor (100) and a LiDAR cleaning system (10) according to claim 1.
